(19) United States
(12) Patent Application Publication
(10) Pub. No.: US 2006/0286354 A1
(43) Pub. Date: Dec. 21, 2006

(54) Billet sawing process

(76) Inventor: Gary Josey, Crossville, TN (US)

Correspondence Address: PITTS AND BRITTIAN P C, P O BOX 51295, KNOXVILLE, TN, 37950-1295, US

(21) Appl. No.: 11/455,589

(22) Filed: Jun. 19, 2006

Related U.S. Application Data
(60) Provisional application No. 60/691,484, filed on Jun. 20, 2005.

(51) Int. Cl. B32B 3/28

(52) U.S. Cl. 428/184; 428/182

(57) ABSTRACT

A system for the manufacture of corrugated construction panels comprises corrugating a first web with flutes having a height greater than ¼ inch; securing the first web to a second planar web to form a corrugated web; severing a plurality of corrugated panels from the corrugated web; sequentially adhering the plurality of corrugated panels in a stack to form a billet; and simultaneously slicing the billet into a plurality of corrugated construction panels.

### CROSS-REFERENCE TO RELATED APPLICATIONS

This application claims the benefit of the priority of Provisional Application No. 60/691,484 filed Jun. 20, 2005.

### STATEMENT REGARDING FEDERALLY SPONSORED RESEARCH OR DEVELOPMENT

Not Applicable

### BACKGROUND OF THE INVENTION

1. Field of Invention

This invention pertains to a method and apparatus for the high speed manufacture of high strength honeycomb panels.

More particularly, this invention pertains to a method and apparatus for high speed manufacture of corrugated construction panels which are low in weight and high in strength, particularly with relation to forces perpendicular to the plane defined by the panel.

2. Description of the Related Art

Paper honeycomb, specifically kraft paper honeycomb, has been manufactured since the 1940's using a continuous honeycomb system. The process has numerous limitations that include being slow and only relatively narrow widths are available in the product strength direction. Finished products from the continuous honeycomb system also requires expansion to the proper cell size and curing to fix the cell shape, processes that are time consuming, costly and often result in losses and irregularity in the finished product.

Recently, a process has been developed to slit corrugated kraft paper that is then operated on by a complex folding mechanism. An older process forms a triangle cell honeycomb where sheets are limited to sizes to 12′ feet×5 feet by 5 inches and sheets are produced one at a time. Both of these and other existing processes have relatively slow speed and size limitations.

Production speeds of prior honeycomb processes are generally limited to about 30′ to 90′ per minute.

Another paper production process called corrugation is a high speed process in which kraft paper is passed through a mating pair of corrugating flutes to create a sheet having a continuous series of bell curves called flutes. In current production, the flutes generally range from microflutes, called F-Flutes, having a height of about 1/32 inch to A-Flutes having a height of up to ¼ inch. The corrugated kraft paper is then adhered on upper and/or lower surfaces to flat sheet(s) of kraft paper to form the corrugated board for cardboard box manufacture.

Corrugated board may be produced in single, double or triple thicknesses with flat sheets bonding the finished corrugated board in a variety of configurations at speeds up to 1500 feet per minute.

### BRIEF SUMMARY OF THE INVENTION

The present invention is directed to the production of high strength reinforced corrugated honeycomb panels and beams, for example as disclosed in U.S. Pat. No. 5,992,112. According to one embodiment of the present invention, a method for manufacturing corrugated construction panels includes corrugating a first web with flutes having a height preferably greater than ¼ inch. The corrugated first web is secured to a second planar web to form a corrugated web. A plurality of corrugated sheets are severed from the corrugated web. The plurality of corrugated sheets are sequentially adhered in a parallel arrangement in a stack to form a billet. The billet is equal in width to the corrugated web and may be of any determined length and height, but preferably less than about 75′ in length and less than about 8.5° in height. The billet is then transferred to a sawing station where it is simultaneously sliced by a plurality of rotating blades into a plurality of corrugated construction panels or beams. The present invention permits the production of honeycomb panels as large as 8.5° by 75′ and at production speeds of 900′ per minute.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is an elevation view of a corrugated board.

FIG. 2 is an elevation view of a stack of corrugated boards.

FIG. 3 is a perspective view of a billet.

FIG. 4 is a perspective view of a slicing apparatus in accordance with the present invention.

FIG. 5 is an elevation view of a blade in accordance with the present invention.

FIG. 6 is a perspective view of an apparatus for rotating a sliced billet 90°.

FIG. 7 is a perspective view of a pair of corrugating rollers adapted for the present invention.

### DETAILED DESCRIPTION OF THE INVENTION

A method and apparatus for manufacturing corrugated construction panels is disclosed. In the drawings, like numbered parts refer to like parts.

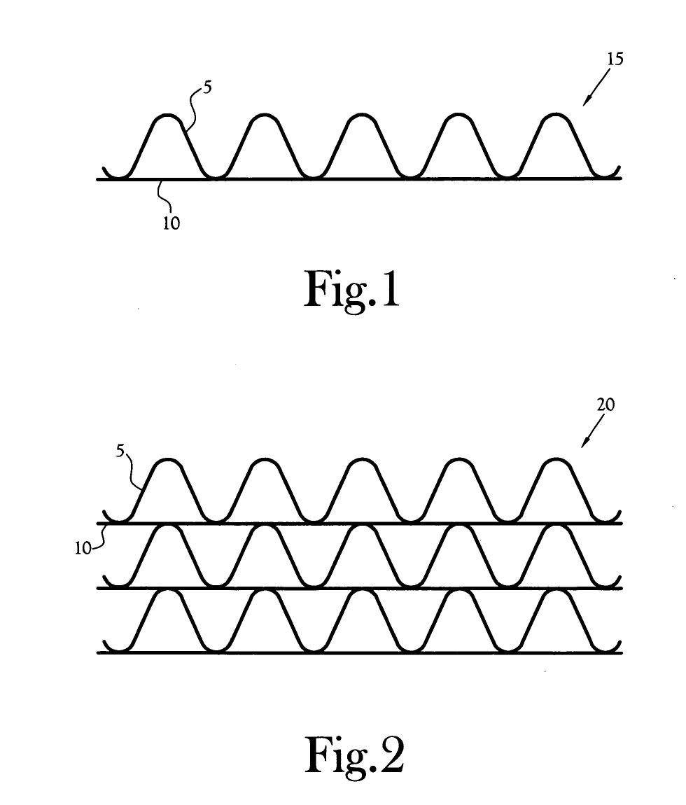

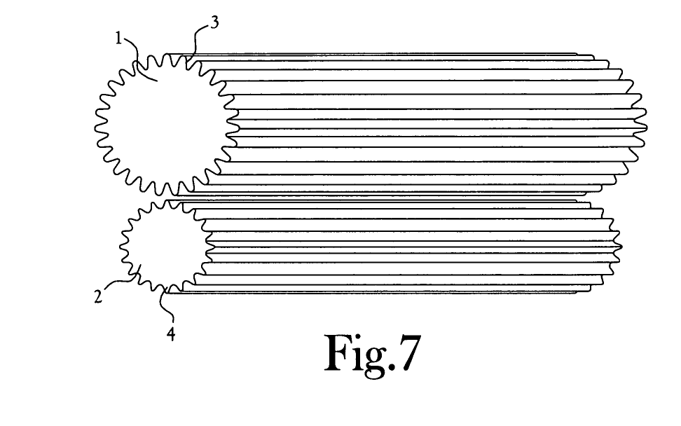

Referring to FIG. 1 and FIG. 7, in accordance with the present invention, a first web 5 is corrugated by a mated pair of corrugating rollers 1 and 2 to form a plurality of flutes, each having a height of ¼ inch or more. The roller 1 has a diameter which is approximately twice the diameter of the roller 2. The flutes 4 defined on the roller 2 have a height:width ratio which is substantially greater than the height:width ratio of the flutes 3 defined on the roller 1. The flutes defined in the first web 5 are transverse to the direction of flow of the web 5. The first web 5 is adhered to a second web 10, which is generally planar, to form a corrugated board 15. The adhesive used is moisture based and ambient cured with an open time determined to be fully cured by the time that the billet 25 is conveyed to the sawing station or, in the alternative, prepared for shipping as a complete billet.

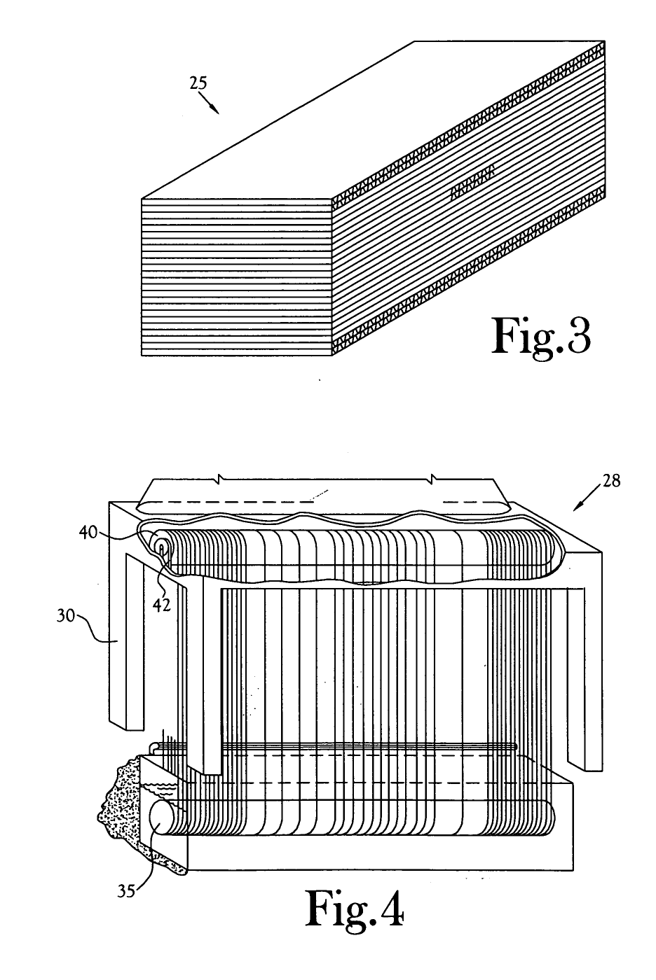

The corrugated board 15 is sequentially severed in lengths up to 75′ to form corrugated sheets 20 of equivalent lengths. An adhesive is applied to each sheet as they are sequentially stacked as depicted in FIG. 2 to form a billet 25, as depicted in FIG. 3. The adhesive used is moisture based and ambient cured with an open time determined to be fully cured by the time that the billet 25 is conveyed to the sawing station or, in the alternative, prepared for shipping as a complete billet. Preferably, the stacks are formed on a scissor table finitely calibrated to allow precisely coordinated vertical movement so that sheets 20 may be transferred onto the stack using vacuum transfer devices known in the art.

The sheets are indexed with a dry sheet being first placed on the scissor table. As subsequent sheets 20 have an adhesive applied to their lower surface, they are added to the stack and the scissor table is lowered incrementally. When the sheets 20 have been stacked to reach the height of the desired billet 25, typically not more than 102″, the billet 25 is transferred, as by conveyor, for example, to a sawing station 28, depicted in FIG. 4, for sawing into a plurality of panels and/or beams.

The sawing station 28 includes a frame 30. A first elongated cylinder 40 is rotatably mounted upon the frame 30 at a height sufficient to allow a billet 25 to pass through the frame under the first elongated cylinder 40. A second elongated cylinder 35 is rotatably mounted below the frame 30 in an orientation that is generally parallel to the first cylinder 40. A driving mechanism, such as the rotating belt 42, effects axial rotation of the first cylinder 40.

A plurality of rotating blades 45 are mounted upon the first elongated cylinder 40 and said second elongated cylinder 35 in a generally parallel orientation, whereby rotation of the elongated cylinders 35 and 40 cause the blades 45 to rotate in a generally parallel manner. The blades 45 are continuously cooled and vacuumed to remove dust and particulate matter created by the sawing process.

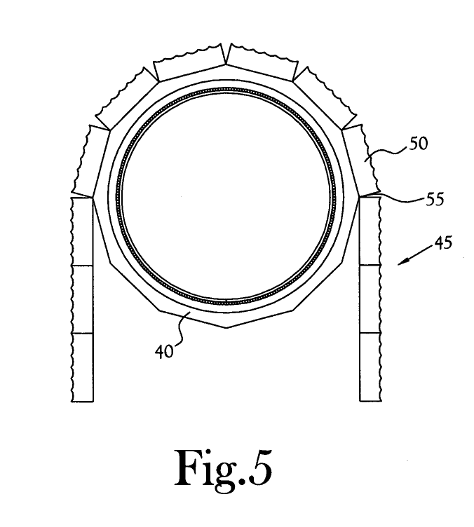

The rotating blades 45 are kerfed serrated blades. Preferably, the blades 45 comprise a plurality of individual blades 50 which are hinged at each end 55 to allow the blade 45 to pass over the rotating cylinders 35 and 40 in a vertical configuration, as depicted in FIG. 5.

The rotating blades 45 are individually mounted upon the cylinders 35 and 40 to allow the blades 45 to be spaced apart by equivalent distances or varying distances. This adjustability allows a single billet 25 to be sawn into panels of varying thickness in a single pass.

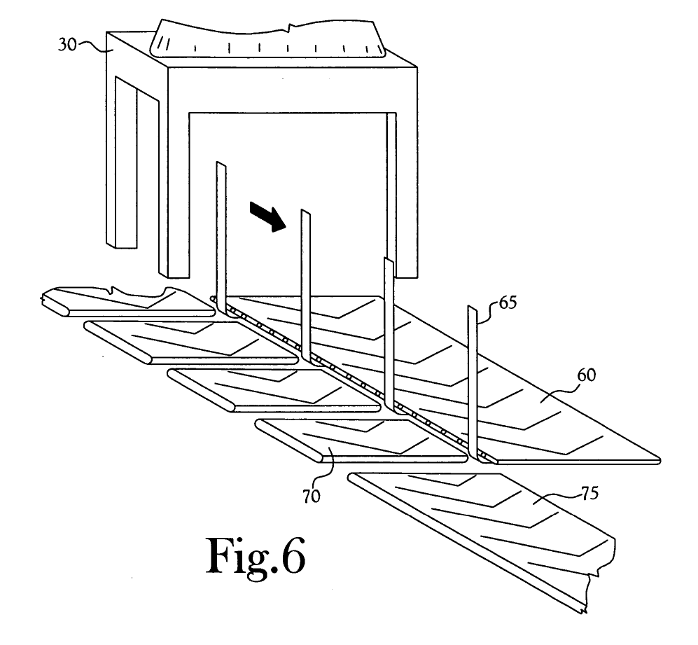

As a billet 25 passes through the sawing station 28, it is vertically sliced into a plurality of panels which pass onto a conveyor bed 60. The conveyor bed 60 includes fingers 65 which extend vertically upwardly from the conveyor bed 60. The conveyor bed 60 is rotatable 90° in order to rotate the billet 25 onto a plurality of intermediate conveyors 70. Rotation of the conveyor bed 60 may be accomplished by electrical, mechanical or hydraulic means. The intermediate conveyors 70 are spaced apart to allow the fingers 65 to deposit the sliced billet 25 onto the conveyors 70 and then nestle between the transfer conveyors 70. After the conveyors 70 have transported the sliced billet 25 onto the exit conveyor 75, the conveyor bed 60 is rotatable 90° back to the orientation depicted in FIG. 6.

The conveying systems used to feed the billet 25 through the sawing station 28 may be hydraulic, mechanical or electromechanical. As the billet 25 is conveyed through the sawing station 28, low friction rollers maintain the alignment of the billet 25 for precision cuts.

As desired, the sliced panels of the billet 25 may be cut to shorter sub-panels using a reciprocating saw. For example, a twenty foot long billet may be sawn into slices having a thickness of 1¾, and then cut into sub-panels having lengths of 6′ 8″, a typical size for a core panel for a door.

Depending upon the application, face sheets may be adhered to the outer surfaces of the panels to create sandwiches.

The present invention permits the production of large size construction panels which may be used for strong, light-weight roof decks and wall panels. In addition, panels of varying thickness may be produced simultaneously from a single billet.

Those skilled in the art will recognize that various modifications in the transferring equipment can be used without departing from the spirit and scope of the present invention.

From the foregoing description, it will be recognized by those skilled in the art that an improved method and apparatus for high speed manufacture of corrugated construction panels which are low in weight and high in strength has been provided.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A method for manufacturing corrugated construction panels comprising:
corrugating a first web with flutes;
securing said first web to a second web to form a corrugated web;
severing a plurality of corrugated sheets from said corrugated web;
sequentially adhering said plurality of corrugated sheets in a stack to form a billet; and
simultaneously slicing said billet into a plurality of corrugated construction panels.

2. The method of claim 1 wherein said simultaneous slicing is performed by a plurality of parallel rotating blades.

3. The method of claim 2 wherein each said rotating blade comprises a plurality of kerfed blades.

4. The method of claim 1 wherein said billet is rotated 90° after the step of simultaneous slicing.

5. The method of claim 1 and further comprising the step of severing said corrugated construction panels into a plurality of sub-panels.

6. The method of claim 1 wherein said first web is corrugated with flutes having a height greater than ¼″.

7. A corrugated construction panel manufactured in accordance with claim 1.

8. A corrugated construction panel manufactured in accordance with claim 2.

9. A corrugated construction panel manufactured in accordance with claim 3.

10. A corrugated construction panel manufactured in accordance with claim 4.

11. A corrugated construction panel manufactured in accordance with claim 5.

12. A corrugated construction panel manufactured in accordance with claim 6.

13. An apparatus for simultaneously slicing a billet into a plurality of corrugated construction panels comprising:
a first elongated cylinder rotatably mounted upon a frame,
a second elongated cylinder rotatably mounted in spaced relationship to said first elongated cylinder and oriented generally parallel to said first cylinder;
a driver for rotating said first elongated cylinder; and
a plurality of rotating blades mounted upon said first elongated cylinder and said second elongated cylinder in a generally parallel orientation.

14. An apparatus in accordance with claim 13 wherein said blades are spaced apart by varying distances.

15. An apparatus in accordance with claim 13 wherein each of said rotating blades comprises a plurality of kerfed blades.

16. An apparatus in accordance with claim 15 wherein said kerfed blades are hingedly connected to form a blade.
